(19) United States
(12) Patent Application Publication
(10) Pub. No.: US 2005/0229112 A1
(43) Pub. Date: Oct. 13, 2005

(54) Method and system for conveying an image position

(76) Inventors: Timothy M. Clay, Boynton Beach, FL (US); Timothy D. Klemm, Lake Worth, FL (US); James P. Mason, Margate, FL (US); Joseph Patino, Pembroke Pines, FL (US)

Correspondence Address: Larry G. Brown;Motorola, Inc., Law Department, 8000 West Sunrise Boulevard, Fort Lauderdale, FL, 33322, US

(21) Appl. No.: 10/822,898

(22) Filed: Apr. 13, 2004

(51) Int. Cl. G06F 3/00

(52) U.S. Cl. 715/817; 715/816; 715/810; 715/838; 715/861

(57) ABSTRACT

The invention concerns a system (100) and method (300, 600) of conveying an image (400, 700, 800) position. The method includes the steps of displaying (312, 612) at least a portion of an image on a display (112) and modifying (314, 614) the portion of the image to convey to a user a position of the portion of the image in relation to the entire image. The image can include a background (412) and at least one symbol (410) superimposed on the background. The modifying step can include graduating (316) the contrast of at least a portion of the background in relation to the symbols. In addition, the step of graduating the contrast includes varying (318) at least one of the hue, brightness and saturation of the background.

### CROSS REFERENCE TO RELATED APPLICATIONS

(Not Applicable)

### BACKGROUND

1. Technical Field

This invention relates in general to user interfaces and more particularly to displays that display information.

2. Description of the Related Art

Portable electronic devices have become ubiquitous in today's society. Virtually all these devices include displays for displaying information to a user. Much of this information is displayed as a list or a set of entries. For example, a user of a cellular telephone may have the option of programming an electronic phonebook with the names and contact information of numerous business and personal acquaintances. When accessing this information, the entries in the phonebook can be displayed on the display of the cellular telephone. In addition to the electronic phonebook, many menus have numerous entries from which a user can make one or more selections to perform a certain function.

Many of these lists contain a large number of entries. For example, an electronic phone book may contain well over one hundred entries of contacts. Because of their small size, however, the display of a portable device may only show a small portion of these entries. In view of the limited number of entries that are displayed, a user may not be aware of the positioning of the displayed entries in relation to the entire list. As an example, if three entries in a list having over fifty entries are currently being displayed on a display, the user may have no idea how close these entries are to the top or bottom of the list.

To provide a user with an indication of the positioning of currently displayed entries in a list, many displays display a scroll bar. A segment of the scroll bar moves vertically as the user moves through the list, and the segment's relation to the fixed portion of the scroll bar corresponds to the user's current positioning of the list. Unfortunately, the displays on virtually all portable devices have a limited amount of space for displaying items. As such, the scroll bar takes up valuable display space.

### SUMMARY OF THE INVENTION

The present invention concerns a method of conveying an image position. The method includes the steps of displaying at least a portion of an image on a display and modifying the portion of the image to convey to a user a position of the portion of the image in relation to the entire image. In one arrangement, the image can include a background and at least one symbol superimposed on the background. The modifying step can include graduating the contrast of at least a portion of the background in relation to the symbols. In addition, the step of graduating the contrast includes varying at least one of the hue, brightness and saturation of the background.

The modifying step can also include graduating the contrast of at least a portion of the symbols in relation to the background or graduating the contrast of at least a portion of the background and the symbols in relation to one another. In either arrangement, the step of graduating the contrast can include varying at least one of the hue, brightness and saturation of the symbols or the background.

In one embodiment, the image can be substantially fixed. As an example, the background can be a bitmap, the symbol can be a list that can include at least one entry and the number of entries in the list can be fixed. In an alternative embodiment, the image may be adjustable, and the method can further include the step of scaling the image to accommodate changes to the image. For example, the background can be a bitmap, the symbol can be a list that includes at least one entry and the number of entries in the list can be capable of being adjusted. The background bitmap can be scaled to accommodate changes in the number of entries in the list.

In yet another arrangement, the modifying the image step can include the step of inserting positional indicators in the image. For example, the image can include at least one list entry, and the positional indicators can be selectively superimposed over the list entries based on the number of list entries.

The present invention also concerns a method of conveying an image position. The method includes the steps of displaying on a display at least a portion of a list and a background—in which the list contains at least one entry and the entries are superimposed on the background—and graduating the contrast of at least a portion of the background in relation to the entries of the list to indicate to a user the position of displayed entries in relation to the entire list.

The present invention also concerns a system for conveying an image position. The system includes a display in which the display displays at least a portion of an image and a processing unit coupled to the display. The processing unit modifies the portion of the image to convey to a user a position of the portion of the image in relation to the entire image. The system also includes suitable software and circuitry to carry out the processes described above.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates a system for conveying an image position in accordance with an embodiment of the inventive arrangements;

FIG. 2 illustrates several of the components of the system of FIG. 1 for conveying an image position in accordance with an embodiment of the inventive arrangements;

FIG. 3 illustrates a method for conveying an image position in accordance with an embodiment of the inventive arrangements;

FIG. 4 illustrates an approximate top section of an image in accordance with an embodiment of the inventive arrangements;

FIG. 5 illustrates an approximate middle section of an image in accordance with an embodiment of the inventive arrangements;

FIG. 6 illustrates an approximate bottom section of an image in accordance with an embodiment of the inventive arrangements;

FIG. 7 illustrates a portion of another image in accordance with an embodiment of the inventive arrangements;

FIG. 8 illustrates another method for conveying an image position in accordance with an embodiment of the inventive arrangements;

FIG. 9 illustrates an approximate top section of an image in accordance with an embodiment of the inventive arrangements;

FIG. 10 illustrates an approximate middle section of an image in accordance with an embodiment of the inventive arrangements;

FIG. 11 illustrates an approximate bottom section of an image in accordance with an embodiment of the inventive arrangements;

FIG. 12 illustrates an approximate top section of an image in accordance with an embodiment of the inventive arrangements;

FIG. 13 illustrates an approximate middle section of an image in accordance with an embodiment of the inventive arrangements; and

FIG. 14 illustrates an approximate bottom section of an image in accordance with an embodiment of the inventive arrangements.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward.

Referring to FIG. 1, a system 100 for conveying an image position is shown. As an example, the system 100 can include an electronic device 110 that includes a display 112 and a keypad 114 for entering information into the electronic device 110. The display 112 can be any suitable type of display. In one arrangement, the electronic device 110 can be a portable electronic device, such as a cellular telephone or a personal digital assistant. Of course, the invention is not limited to these examples, as the electronic device 110 can be any device capable of displaying an image.

The display 112 of the electronic device 110 can display virtually any type of image. Examples of images can include still pictures, video, symbols (including text), animated objects or a combination of any of the foregoing. It is understood that the invention is not limited to these examples, as other suitable material or information may serve as an image. In addition, the display 112 may serve as a conventional display in which images are shown on a unit contained within the electronic device 110, which is the arrangement pictured in FIG. 1. It must be noted, however, that the display 112 can also include a projection system in which at least a portion of the image is projected onto a surface, such as a wall or screen.

In one particular arrangement and without limitation, the display 112 is capable of displaying a list having one or more entries. As an example, the list can be the entries for a phonebook, which when selected can give information related to a person or business identified by the entry. The list can also be entries for a menu or for any other collection of data. All the entries for a particular list may not be able to be shown simultaneously on the display 112 because the display 112 is simply too small to show all the entries. In accordance with one embodiment of the inventive arrangements, the background on which the list entries are superimposed can be modified to indicate to a user his position in relation to the entire list if the user can see only a portion of the list. This process will be explained further below.

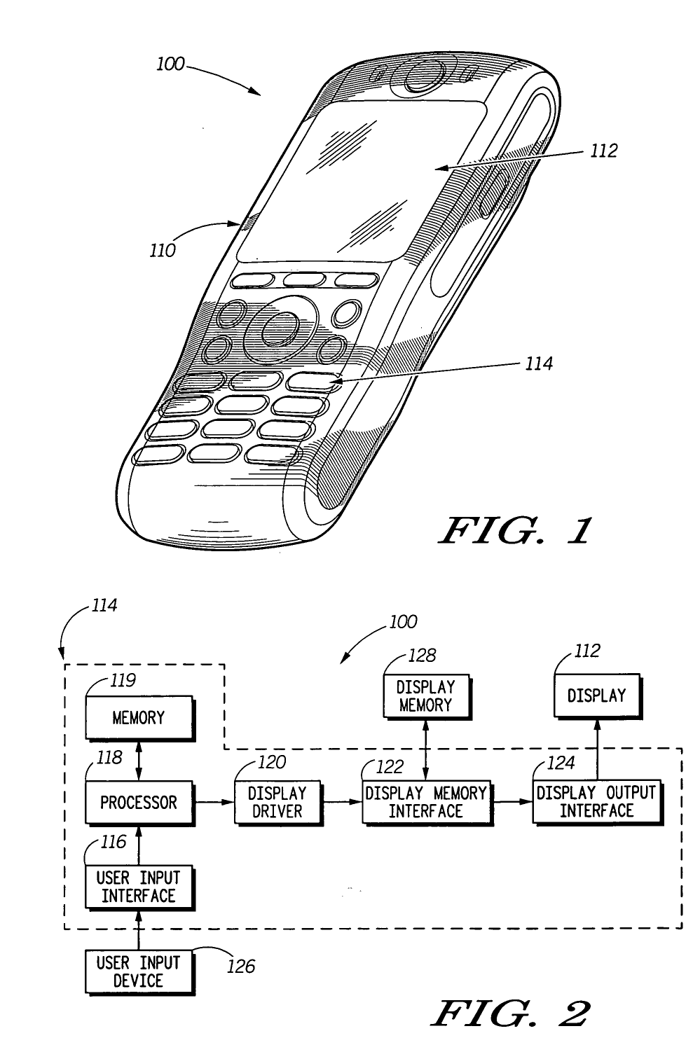

Referring to FIG. 2, several components of the electronic device 110 of the system 100 are shown. It must be noted that the invention is in no way limited to the components shown and described in relation to FIG. 2. That is, other suitable systems or components can be used to practice the invention. In one arrangement, the electronic device 110, in addition to the display 112 and the keypad 114 (see FIG. 1), can include a processing unit 114. The processing unit 114 can include a user input interface 116, a processor 118, a memory 119, a display driver 120, a display memory interface 122 and a display output interface 124. Further, the electronic device 110 can include a user input device 126 (such as the keypad 114) and a display memory 128, and the processing unit 114 can be coupled to both the user input device 126 and the display memory 128. Each of the components described above may correspond to software routines or sections or hardware interfaces or a combination thereof.

The user input device 126 can receive input from a user and can provide the input to the user input interface 116. As an example, the user input device 126 can be the keypad 114 (see FIG. 1), although the user input device 126 can be any other suitable component for receiving a user input. If the user input device 126 is a touch-screen display, the user input device 126 and the display 112 can be integrated into a single unit. The user input interface 116 can receive the user input from the user input device 126 and can provide the input to the processor 118.

The processor 118 can be programmed to execute any number of applications for operating the electronic device 110 and can access these applications or other data from the memory 119. For displaying information to a user, the processor 118 can receive the input from the user input interface 116 and access the appropriate data from the memory 119. The processor 118 can then provide display data to the display driver 120. In response, the display driver 120 can generate a display signal to be presented on the display 112. This display signal can be either a color signal or a monochromatic signal, depending on the capabilities of the display 112.

The display driver 120 can be coupled to the display memory interface 122, which can be coupled to the display memory 128. In one arrangement, the display memory 128 can have a data location for the pixels of the display 112. The display driver 120, through the display memory interface 122, can change the output of the display 112 by, for example, overwriting the data values of the memory locations corresponding to pixels that are to be modified.

The display memory interface 122 can also be coupled to the display output interface 124. The display output interface 124 can read the data values from the display memory 128 through the display memory interface 122. The display output interface 124 can then generate an appropriate output signal for the display 112, and the desired image can be displayed on the display 112. The display 122, because of its possibly limited size, may not be able to show the entire image. In accordance with one embodiment of the invention, the processing unit 114 can modify portions of the image to enable a user to determine the portion of the image that he or she is currently viewing in relation to the entire image, examples of which will be given below.

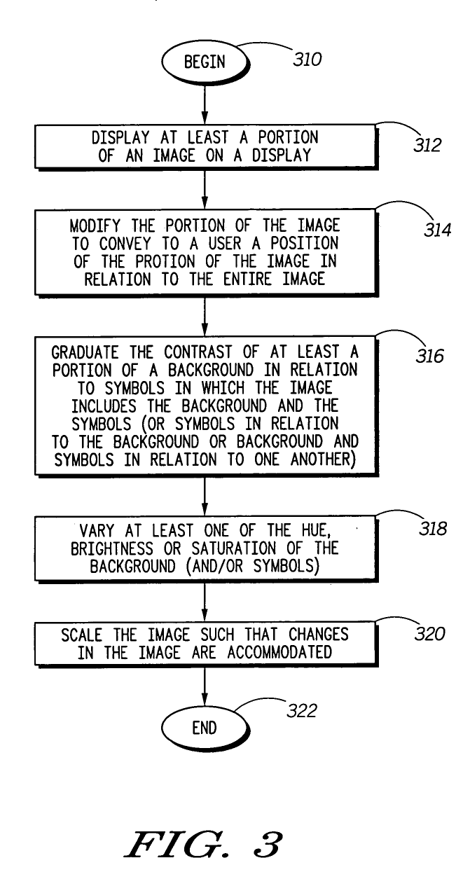

Referring to FIG. 3, a method 300 for conveying an image position is illustrated. To describe the method 300, reference will be made to the components of the electronic device 110 of FIG. 2, although it is understood that the method 300 can be practiced in any other suitable system. At step 310, the method 300 can begin. At step 312, at least a portion of an image can be displayed on a display. For example, referring to FIG. 2, the processing unit 114 can cause any suitable image can be displayed on the display 112. For purposes of the invention, the term image can mean any visual representation that can be displayed on or by the display 112. As an example and as noted earlier, the image can be still pictures, video, symbols (including text), animated objects or a combination of any of the foregoing. Referring back to the method 300 of FIG. 3, at step 314, the portion of the image can be modified to convey to a user a position of the portion of the image in relation to the entire image.

The invention contemplates numerous methods for modifying the image. Step 316 presents one such example. At step 316, the image can include a background and symbols, and the contrast of at least a portion of the background in relation to the symbols can be graduated. For purposes of the invention, the phrase “graduate the contrast” can mean to accentuate the differences between two or more elements in varying stages, whether in increasing or decreasing degree. As an example, the contrast of the background in relation to the symbols can be graduated by varying the hue, brightness or saturation of the background, as shown in step 318. In another arrangement, the contrast of the symbols can be graduated in relation to the background or the contrast of both the background and the symbols can be graduated in relation to one another, which is also shown in the step 316. The contrast of the symbols can also be graduated by varying the hue, brightness or saturation of the symbols, as shown in step 318.

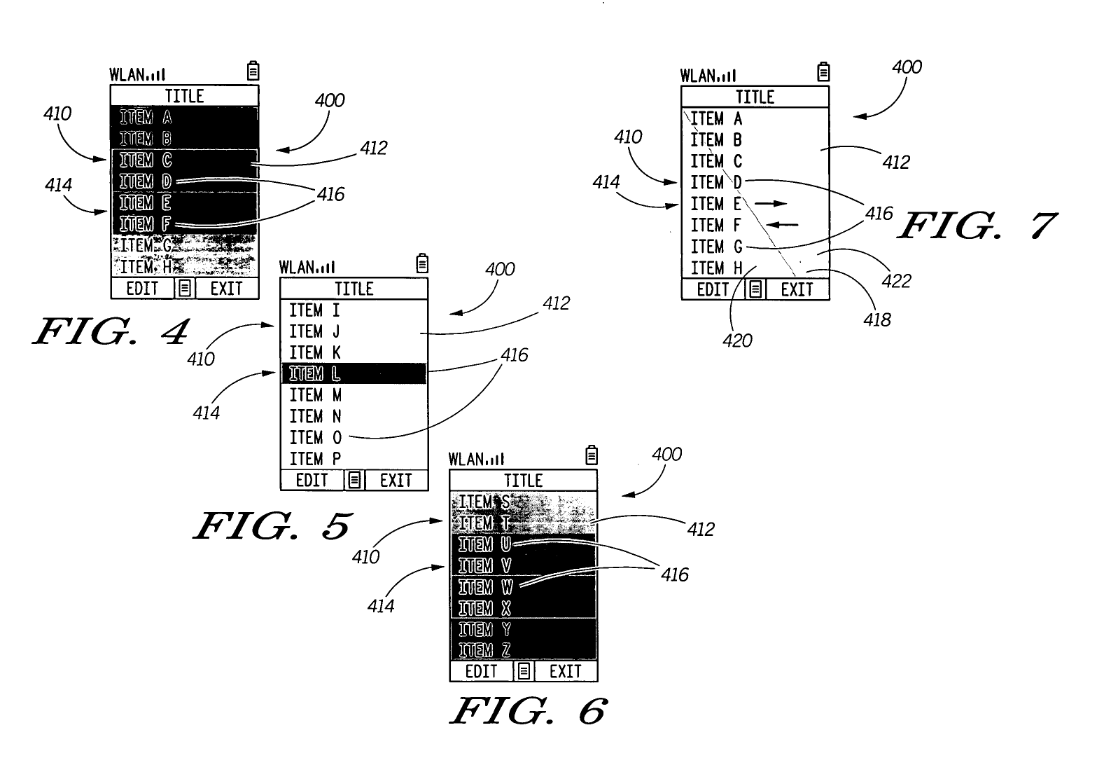

One example of modifying an image in accordance with the inventive arrangements will now be illustrated. Referring to FIG. 4, a portion of an image 400 is shown in which the image contains one or more symbols 410 and a background 412 in which the symbol 410 is superimposed on the background 412. The image 400 can be displayed on the display 112 (see FIGS. 1 and 2). In this example, the symbol 410 can be a list 414 having one or more entries 416 in which the list 414 can be part of a menu or other collection of data. Here, the list 414 contains more entries 416 than can be shown on the display 112 at one time, and FIG. 4 corresponds roughly to the top portion of the image 400. Portions of the remainder of the image are shown in FIGS. 5 and 6, in which FIG. 5 corresponds roughly to the middle section of the image and FIG. 6 corresponds roughly to the bottom section of the image 400.

To convey to a user the position of the image 400, the contrast of the background 412 can graduate or change with respect to the entries 416 of the list 414. For example, at and near the top of the list 414 (see FIG. 4), the background 412 can be relatively dark, and as the list 414 progresses, the background 412 can become lighter. Based on this depiction, the user can glean that he or she is near the top of the image 400. As the user scrolls down the image 400, for example, from FIG. 4 to FIG. 5, the background 412 can become even lighter, and the user can understand that he or she is near the middle of the image 400. Further, moving from FIG. 5 to FIG. 6, the background 412 can move from being light to being relatively dark, and the user can determine that he or she is near the bottom of the image 400. In this arrangement, the user can determine the positioning of a portion of the image 400 in relation to the entire image 400 without the use of a scroll bar or other positional indicator icon.

It is understood that the invention is in no way limited to the particular example described above. Other suitable methods for modifying an image for purposes of providing positional information can be used. As an example, the contrast of the symbol 410 in relation to the background 412 can be graduated (see also steps 316 and 318 of the method 300 of FIG. 3). More specifically, the contrast of the entries 416 of the list 414 can be graduated in relation to the background 412. That is, a process for conveying an image position similar to that described in relation to FIGS. 4-6 can occur with a slight modification in that the contrast of the symbols 410 can be graduated in comparison to the background 412, which can be left substantially unchanged. Additionally, the contrast of both the background 412 and the symbol 410 can be graduated in comparison to one another (see also steps 316 and 318). In other words, both the background 412 and the symbol 410 can be modified for purposes of informing a user of positional information.

Referring to FIG. 7, another example of modifying the image 400 is shown. There, the contrast of the background 412 can be graduated in relation to the symbol 410 (i.e., entries 416 of the list 414) through the use of a diagonal boundary 418. A first side 420 of the boundary 418 can be relatively dark, and a second side 422 of the boundary 418 can be relatively light. As the user scrolls down the list 414, more and more of the background 412 can become darker, thereby indicating that the user is approaching the bottom of the list 414. Again, the invention is not limited to this particular example, as any other suitable method for conveying an image position can be used.

In one arrangement, the image 400 can be a substantially fixed set of data in which the image 400 remains relatively fixed or unchanged over time. As an example, the list 414 in FIGS. 4-6 and 7 can be a menu in which the number of entries 416 in the list 414 is fixed or set and cannot be changed by the user. Alternatively, the image 400 can be a set of data that can be altered by the user. For example, the entries 416 of the list 414 can be phonebook entries in which the number of entries 416 in the list 414 can be adjusted, e.g., added to or removed from the list 414.

Referring to FIGS. 2 and 4-7, once it determines that a particular image 400 is to be displayed, the processing unit 114 can access all or portions of the image 400 from the memory 119. In accordance with the example described above, the processing unit 114 can retrieve the background 412 and the symbol 410—in this case, the list 414—and can cause them to be displayed on the display 112.

The processing unit 114 can be the component of the system 100 that modifies the image 400 for purposes of conveying to a user the position of at least a portion of the image 400 in relation to the entire image 400. As alluded to earlier, the processing unit 114 can graduate the contrast of the background 412 in comparison to the symbol 410 (or list 414) by varying the hue, brightness or saturation of the background 412. Of course, other elements of the background 412 can be modified to carry out this process. In addition and based on the discussion above, the processing unit 114 can graduate the contrast of the symbol 410 (or list 414) in relation to the background 412 or the contrast of the background 412 and the symbol 412 in relation to one another.

As noted above, the image 400 can be substantially fixed or can be adjustable. Referring to the method 300 of FIG. 3, if the image is adjustable, the image can be scaled to accommodate changes to the image, as shown at step 320. For example, referring to FIGS. 2 and 4-7, the image 400 can include the background 412 and the symbol 410 in which the background 412 is a bitmap and the symbol 410 is the list 414 having one or more entries 416. If entries 416 are added or deleted from the list 414, the processing unit 114 can scale the background bitmap 412 to accommodate the change in the number of entries 416.

As a further example, if additional entries 416 are added to the list 414, the background bitmap 412 can be altered such that the background 412 moves from being relatively dark to relatively light and back to being relatively dark (see FIGS. 4-6) in a slower progression as the user scrolls along the image 400. If entries 416 are removed from the list 414, the progression from the background 412 being relatively dark to relatively light and back to being relatively dark can occur faster as the user scrolls the image 400. Alternatively, the background 412 of FIG. 7 can be altered such that the diagonal boundary 418 can move across the display 112 (shown by the arrows) slower as a user scrolls the display 112 after entries 416 are added or faster after entries 416 are removed. Referring back to FIG. 3, the method 300 can end at step 322.

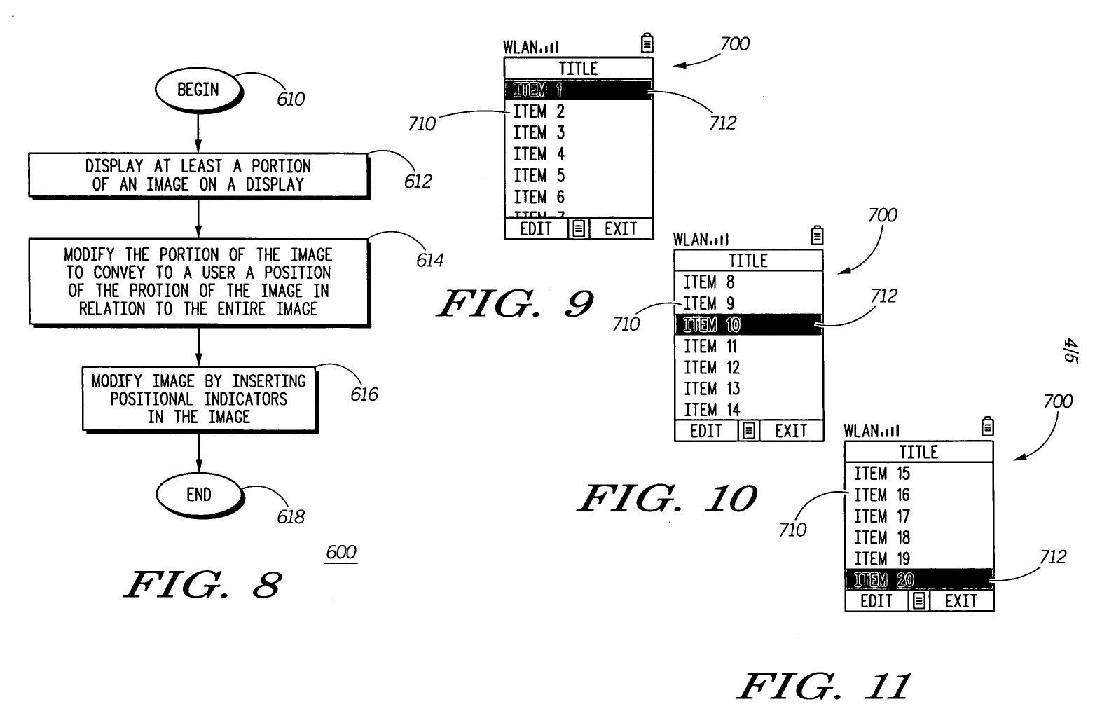

Referring to FIG. 8, another method 600 for conveying the position of an image is shown. Once again, when describing the method 600, reference will be made to FIG. 2, although the method 600 can be practiced in any other suitable system. At step 610, the method 600 can begin. At step 612, at least a portion of an image can be displayed, and the portion of the image can be modified to convey to a user a position of the portion of the image in relation to the entire image, as shown at step 614. Step 616 shows an example of how the image can be modified. In particular, at step 616, the image can be modified by inserting positional indicators in the image. The method 600 can stop at step 618.

Referring to FIGS. 2 and 9, an image 700 is illustrated in which the image 700 includes at least one list entry 710. The top portion of the image 700 is illustrated by FIG. 9, while the middle portion of the image 700 and the bottom portion of the image 700 are illustrated by FIGS. 10 and 11, respectively. In this example and as shown in FIGS. 9-11, the processing unit 114 can selectively superimpose one or more positional indicators 712 over the list entries 710. By selectively superimposing the positional indicators 712 over the list entries 710, a user can determine the position of the image 700 being displayed in relation to the entire image.

For example, referring to FIG. 9, the user may see the positional indicator 712 and can understand that he or she is at or near the top of the image 700. In addition, referring to FIGS. 10 and 11, the user can observe the positional indicators 712 and can determine that he or she is near the middle or the bottom of the image, respectively. Certain steps can be taken to distinguish positional indicators 712. As an example, a positional indicator 712 can have a different color, shape or pattern as compared to another positional indicator 712 to help distinguish them from one another. Of course, other ways to help distinguish positional indicators 712 from one another may be employed.

In one arrangement, all or some of the positional indicators 712 can be superimposed over the list entries 710 based on the number of list entries 710. For example, referring to FIGS. 2 and 9-11, if the image 700 presented in FIGS. 9-11 contains twenty list entries 710, then the processing unit 114 can superimpose the positional indicator 712 present in FIG. 10 over the tenth list entry 710, which can correspond to the approximate middle of the image 700. If the number of list entries 710 is changed, then the processing unit 114 can reposition the positional indicator 712 to the new approximate middle of the image 700. It is understood, however, that the positioning of the positional indicators 712 is not limited to the number of list entries 710 in an image 700, as other factors may be considered when superimposing the positional indicators 712 over the list entries 710.

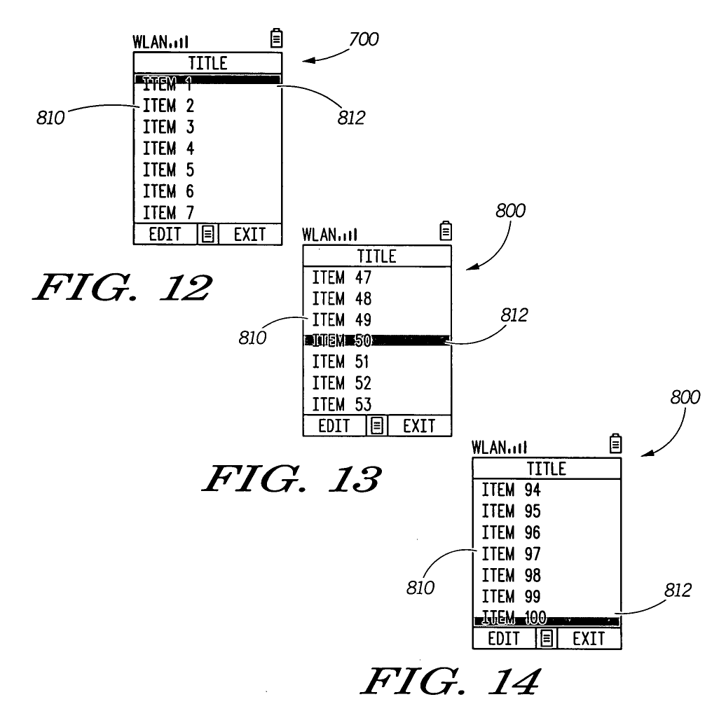

In another arrangement, the characteristics of the positional indicators 712 may also be changed in response to an adjustment in the number of list entries 710 in the image 700. For example, referring to FIGS. 2 and 12-14, an image 800 may contain a large number of list entries 810, such as 100 list entries 810, especially when compared to the image 700 of FIGS. 9-11. Similar to the image 700, the image 800 in FIGS. 12-14 can include positional indicators 812 for conveying a position of the image 800 (FIGS. 12-14 represent approximate top, middle and bottom portions of the image 800, respectively). In response, the processing unit 114 may alter the positional indicator 812 to indicate to a user that the list of entries 810 is relatively lengthy.

As an example and referring to FIGS. 2 and 13, processing unit 114 can modify the positional indicator 812 such that it is smaller than the positional indicator 712 of FIG. 10. This change in the size of the positional indicator 812 can inform a user that the number of list entries 810 is rather large. Conversely, if the number of list entries 810 is relatively few, the size of the positional indicator 812 can be made bigger to indicate such a setting. These modifications of the positional indicators 812 can also apply to those pictured in FIGS. 12 and 14.

It must be noted, however, that the invention is not limited to these particular examples, as the positional indicators 810 can be modified in other suitable ways for purposes of providing a guide as to how long (or short) a particular list of entries 810 is. Moreover, the positional indicators 712, 812 of FIGS. 9-11 and 12-14 are not limited to the positioning described in those drawings, as they can be positioned in other suitable locations to provide a user with positional information.

While several examples of modifying an image to convey the position of the image have been described, it is understood that the invention is in no way limited to any of them. Other suitable processes or methods can be used to carry out such a function. Also, while the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

1. A method of conveying an image position, comprising the steps of:
displaying at least a portion of an image on a display; and
modifying the portion of the image to convey to a user a position of the portion of the image in relation to the entire image.

2. The method according to claim 1, wherein the image includes a background and at least one symbol superimposed on the background and wherein the modifying step comprises graduating the contrast of at least a portion of the background in relation to the symbols.

3. The method according to claim 2, wherein the step of graduating the contrast includes varying at least one of the hue, brightness and saturation of the background.

4. The method according to claim 1, wherein the image includes a background and at least one symbol superimposed on the background and wherein the modifying step further comprises graduating the contrast of at least a portion of the symbols in relation to the background.

5. The method according to claim 4, wherein the step of graduating the contrast includes varying at least one of the hue, brightness and saturation of the symbols.

6. The method according to claim 1, wherein the image includes a background and at least one symbol superimposed on the background and wherein the modifying step comprises graduating the contrast of at least a portion of the background and the symbols in relation to one another.

7. The method according to claim 6, wherein the step of graduating the contrast includes varying at least one of the hue, brightness and saturation of both the background and the symbols.

8. The method according to claim 1, wherein the image is substantially fixed.

9. The method according to claim 8, wherein the image includes a background and at least one symbol superimposed on the background, wherein the background is a bitmap and the symbol is a list that includes at least one entry and the number of entries in the list is fixed.

10. The method according to claim 1, wherein the image is adjustable and the method further comprises the step of scaling the image to accommodate changes to the image.

11. The method according to claim 10, wherein the image includes a background and at least one symbol superimposed on the background, wherein the background is a bitmap and the symbol is a list that includes at least one entry and the number of entries in the list is capable of being adjusted and the background bitmap is scaled to accommodate changes in the number of entries in the list.

12. The method according to claim 1, wherein the modifying the image step comprises the step of inserting positional indicators in the image.

13. The method according to claim 12, wherein the image includes at least one list entry and the positional indicators are selectively superimposed over the list entries based on the number of list entries.

14. A method of conveying an image position, comprising the step of:
displaying on a display at least a portion of a list and a background, wherein the list contains at least one entry and the entries are superimposed on the background;
graduating the contrast of at least a portion of the background in relation to the entries of the list to indicate to a user the position of displayed entries in relation to the entire list.

15. A system for conveying an image position, comprising:
a display, wherein the display displays at least a portion of an image; and
a processing unit coupled to the display, wherein the processing unit modifies the portion of the image to convey to a user a position of the portion of the image in relation to the entire image.

16. The system according to claim 15, wherein the image includes a background and at least one symbol superimposed on the background, wherein the processing unit modifies the image by graduating the contrast of at least a portion of the background in relation to the symbols.

17. The system according to claim 16, wherein the processing unit graduates the contrast of the background in relation to the symbols by varying at least one of the hue, brightness and saturation of the background.

18. The system according to claim 15, wherein the image includes a background and at least one symbol superimposed on the background, wherein the processing unit modifies the image by graduating the contrast of at least a portion of the symbols in relation to the background.

19. The system according to claim 18, wherein the processing unit graduates the contrast of the symbols in relation to the background by varying at least one of the hue, brightness and saturation of the symbols.

20. The system according to claim 15, wherein the image includes a background and at least one symbol superimposed on the background, wherein the processing unit modifies the image by graduating the contrast of at least a portion of the background and symbols in relation to one another.

21. The system according to claim 20, wherein the processing unit graduates the contrast of the background and the symbols by varying at least one of the hue, brightness and saturation of both the background and the symbols.

22. The system according to claim 15, wherein the image is substantially fixed.

23. The system according to claim 22, wherein image includes a background and at least one symbol superimposed on the background, wherein the background is a bitmap and the symbol is a list that includes at least one entry and the number of entries in the list is fixed.

24. The system according to claim 15, wherein the image is adjustable and the processing unit scales the image to accommodate changes to the image.

25. The system according to claim 24, wherein the image includes a background and at least one symbol superimposed on the background, wherein the background is a bitmap and the symbol is a list that includes at least one entry and the number of entries in the list is capable of being adjusted, wherein the processing unit scales the background bitmap such that the background bitmap accommodates changes in the number of entries in the list.

26. The system according to claim 15, wherein the processing unit modifies the image by inserting positional indicators in the image.

27. The system according to claim 26, wherein the image includes at least one entry and the processing unit selectively superimposes the positional indicators over the list entries based on the number of list entries.

28. A system for conveying an image position, comprising:
a display, wherein the display displays at least a portion of a list and a background, wherein the list contains at least one entry and the entries are superimposed on the background; and
a processing unit coupled to the display, wherein the processing unit graduates the contrast of at least a portion of the background in relation to the entries of the list to indicate to a user the position of displayed entries in relation to the entire list.
